(19) United States
(12) Patent Application Publication
(10) Pub. No.: US 2009/0100409 A1
(43) Pub. Date: Apr. 16, 2009

(54) Game Design Tool

(75) Inventor: Steve Toneguzzo, Rosebery NSW (AU)

Correspondence Address: MICHAEL MOLINS;MOLINS & CO., SUITE 5, LEVEL 6, 139 MACQUARIE ST, SYDNEY NSW, 2000, AU

(73) Assignee: E-Synergies.Com Pty Ltd, Rosebery NSW (AU)

(21) Appl. No.: 12/248,835

(22) Filed: Oct. 9, 2008

(30) Foreign Application Priority Data
Oct. 12, 2007 (AU) 2007905593

(51) Int. Cl. A63F 9/24; G06F 3/048; G06F 9/44; G06Q 30/00; G06Q 50/00

(52) U.S. Cl. 717/113; 715/764; 705/26; 463/23

(57) ABSTRACT

A tool is provided for designing electronic games of chance such as slot or fruit machine games. Software that runs on a computer or remote server takes user inputs and selections such as game rules, input data, and pointers to or import of files (such as sound and graphics files). The output data of such a tool may be a file or parameters that specify one or more of hit rate, return to player, pay-table, symbol mapping, symbols, game theme, risk profile, rules of game play, denomination, language, currency, display, simulation results, pay methods, triggers for game features or jackpots.

### FIELD OF THE INVENTION

The present invention relates to gaming software and, in particular, to a software tool for designing a game of chance, such as may be used for gaming.

### BACKGROUND OF THE INVENTION

Gaming software, irrespective of the medium on which it is played, can be considered to be made up of several major components. These are:
1. The graphics files, that represent symbols in the game, background graphics or player interfaces.
2. The sound files that are translated to an audible sound to be heard by the player upon certain game events or player selections occurring.
3. The game file, which may contain information that identifies one or more of when and how to use the sound and graphic files, defines the rules of play, the mathematics and general operation of the game.
4. The game engine which interprets (through an interface) the game file and causes the game to be played and represented in the manner in which the game file defines.
5. Back-end or ancillary software which will handle accounting processes, control of peripheral devices, security, communications and generally everything else necessary for a game or gaming device to function that is not addressed by components 1 to 4 above.

Games are typically designed by game manufacturers in an iterative manner. Players have no input to the design of games and there are no mechanisms to place a game directly from design into production.

### OBJECTS AND SUMMARY OF THE INVENTION

It is, therefore, an object of the present invention to overcome at least some of the problems of the aforementioned prior art, or at least provide a useful alternative.

It is another object of the present invention to provide a software tool for designing a game of chance by interpreting inputs and generating outputs.

In a broad form of the invention there is provided a software tool for designing a game of chance, the software tool including means for interpreting inputs and means for generating outputs.

### BRIEF DESCRIPTION OF THE DRAWING FIGURES

FIG. 1 is a flow chart of a method of applying the teachings of the present invention;

FIG. 2 is a window of a graphical user interface to a software tool of the present invention illustrating how game setting variables are input by a user;

FIG. 3 is a window of a graphical user interface to a software tool of the present invention illustrating how a symbol table is input by a user;

FIG. 4 is a window of a graphical user interface to a software tool of the present invention illustrating how a pay table is input by a user;

FIG. 5 is a window of a graphical user interface to a software tool of the present invention illustrating a special pay table;

FIG. 6 is a window of a graphical user interface to a software tool of the present invention illustrating how symbol selection variables are input by a user;

FIG. 7 is an output of the present invention illustrating win combinations in a window of a graphical user interface of a software tool whereby the user input is reversed engineered into game parameters;

FIG. 8 is an output of the present invention illustrating the prize table displayed as a window of a graphical user interface to a software tool whereby the user input is reversed engineered into game parameters;

FIG. 9 is an output of the present invention illustrating volatility (risk profile) of the game displayed as a window of a graphical user interface to a software tool whereby the user input is reversed engineered into game parameters;

FIG. 10 is an output of the software tool of the present invention illustrating simulation results generated by the tool;

FIG. 11 is a window of a graphical user interface to a software tool of the present invention illustrating how game engine setting variables are input by a user;

FIG. 12 is a window of a graphical user interface to a software tool of the present invention illustrating a game engine interface;

FIG. 13 is a window of a graphical user interface to a software tool of the present invention illustrating how installation serial number variables are input by a user;

FIG. 14 is a window of a graphical user interface to a software tool of the present invention illustrating how licensing key variables are input by a user;

FIG. 15 is a flow chart of a second method of applying the teachings of the present invention;

FIG. 16 is a flow chart of a third method of applying the teachings of the present invention;

### BEST MODE AND OTHER EMBODIMENTS

The preferred software tool of the present invention includes means for interpreting user inputs or input parameters and means generating outputs (output parameters or data files) over which players have some control.

The output data or parameters for such a tool may be one or more of hit rate, return to player, pay-table, symbol mapping, symbols, game theme, risk profile, rules of game play, denomination, language, currency, display, simulation results, pay methods, triggers for game features or jackpots.

The input parameters may be a selection of options and rules, input data, and pointers to, or import of, files (such as sound and graphics files), generally referred to as “input parameters” or input herein. The input may be a file and a selection of options and rules, parameters, input data, and pointers to, or import of, files.

Such input may be through any form of interface (such as a computer keyboard, spoken, touch screen, graphical user interface, and the like)

The outputs may be displayed on a screen, saved to a file, printed or communicated in any form, directly or indirectly to a game engine.

Such output may be through a game file that is imported directly or through an interface or translator to a game engine. The output may be a game file that is saved on a server for recall or use at a later time.

Such output may also be through a data file or report that may be provided to a regulatory agency or automatically accepted by a regulatory agency for approval of a game to enable the game to go into operation following design.

In all of the above embodiments, the software tool may be accessed via the internet in a system that would enable any person to access the tool, pay a fee, design and trial play a game, and obtain the data that defines the designed game.

In all of the above embodiments, the software tool may be used in marketing or sales for a person to design a game cooperatively with others and demonstrate the game play in real time.

Furthermore, the tool may be used in isolation of a gaming system to design and deploy games. Alternatively, the tool may be used in conjunction with, or as an integrated part of, a gaming system to design and deploy games.

In a practical sense, the software tool may be used with more than one type of game engine.

A player is able to select the type of game they want to play and is provided the option to customize, modify, design or re-design any or all aspects of a game design. In that case, the selections of the player may be directly inputted to the game file or interpreted to modify the game within set parameters. The player can then store the game they customize on a system and recall the game later. Storage of the customized game may be on a personal device, from which the game may be recalled later.

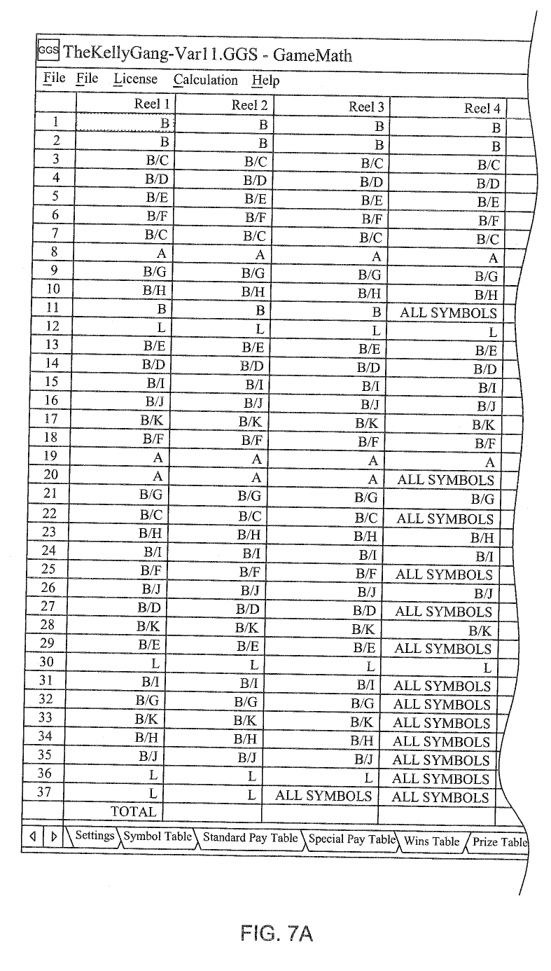

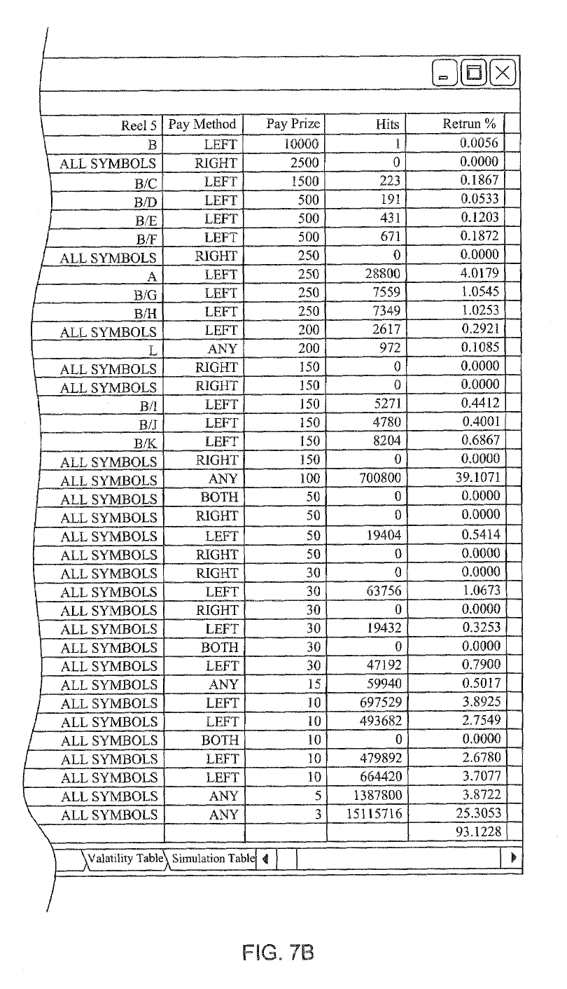

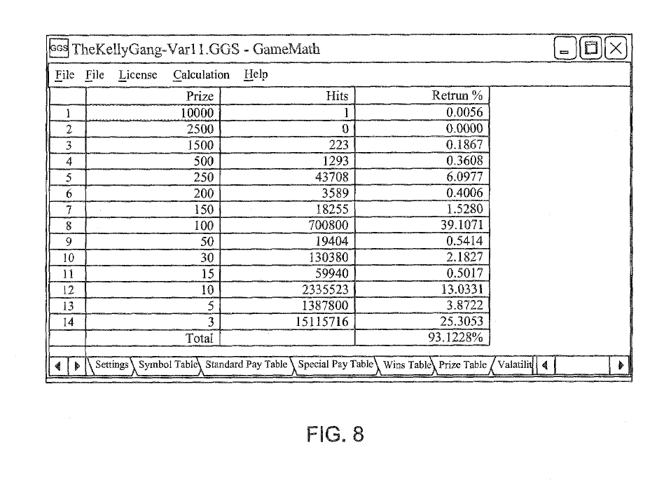

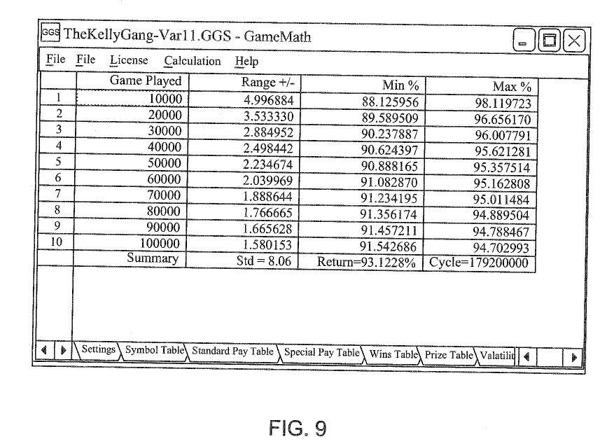

Examples of customer selection are as follows:
1. Jackpot—Yes/No (could turn off the trigger and automatically adjust the return to player through reel distribution or other means to still be within regulatory or other limitations).
2. Feature games—Yes/No (could turn off the trigger and automatically adjust the return to player through reel distribution or other means to still be within regulatory or other limitations).
3. Pay often (could adjust the hit rate).
4. Pay not so often (could adjust the hit rate).
5. Pay more (could adjust the hit rate).
6. Pay less (could adjust the hit rate).
7. The frequency of pay might be represented in another form such as by a meter or a bar or sliding scale.
8. Select the symbols to be on the reels (for example, replace a cherry with the symbol of the favorite ball team).
9. Select the background graphics.
10. Select a theme.
11. Select a language.
12. Select a currency.
13. Select where on the screen the meter should be.
   Thus the present game development tool does the following:
(a) Takes inputs for generating parameters used in the design of a slot game such as number of reels, symbols per reel, frequency of symbols, pay methods, graphics and sound information, and any other parameter that might be considered a variable in the design of a gambling game
(b) Calculates the theoretical return to player for each winning combination and the total sum.
(c) Calculates the risk-profile (or volatility) of the game.
(d) Calculates the hit rate (e.g. how often symbol combinations (we are mostly interesting in winning combinations) occur.
(e) Simulates statistically significant samples of actual game play for comparison with the theoretical calculations of return to player.
(f) Generates a data file that can be imported into a gaming device or system directly.
(g) Generates a report containing information required by gaming regulators and in a required format for assessment and approval of the game.
(h) Uploads the game to a gaming system in real-time for immediate play.
(i) Uploads or otherwise communicates the regulatory report to the gaming regulator in real-time for approval/regulatory records.
(j) Associates the designer of the game with the game, for subsequent use by the gambling device or system in enabling a player to own a game or share in revenue from the game they designed, or invite persons to participate in a game or any other thing where it is important to associate both the game and designer.
(k) Provides for the “reverse engineering” of industry standard algorithms used to produce the results demonstrated in FIGS. 7 through 10 in order to modify the game design parameters as a result of modification to outputs.
   The tool could be installed:
(a) On a stand-alone computing device such as a laptop where it could be used as a sales tool, for example.
(b) In a networked environment such as the internet where it could be used to commoditize game design, for example
(c) On a gaming system or device where the player or operator could use it for design and play.
   The features of this tool are:
(a) The algorithm enables the calculations to be performed in near “real-time”, one embodiment of which is demonstrated by the code in FIG. 17.
(b) The commercial application of “design and play” gaming where a vendor may design and play a game with a customer in real time, an operator may design or modify a game in real-time and push it out to the gaming environment (e.g. as soon as the winning team of the world cup is known), or a player may design and own a game or design and play a game in real time all these possibilities are able to be realized due to the speed of the game design once input parameters are accepted.
(c) The user-friendly interface for a “professional” designer whereby the parameter details are entered through menus and interpreted by the program.
(d) The game design tool enables one to automate differing game design rules
(e) The intuitive user interface for the player, whereby the program interprets visual, audible, or mechanical representations (adopting the senses) into parameters. For example a dial, or a sliding scale or a level to make the game pay more or less frequently.

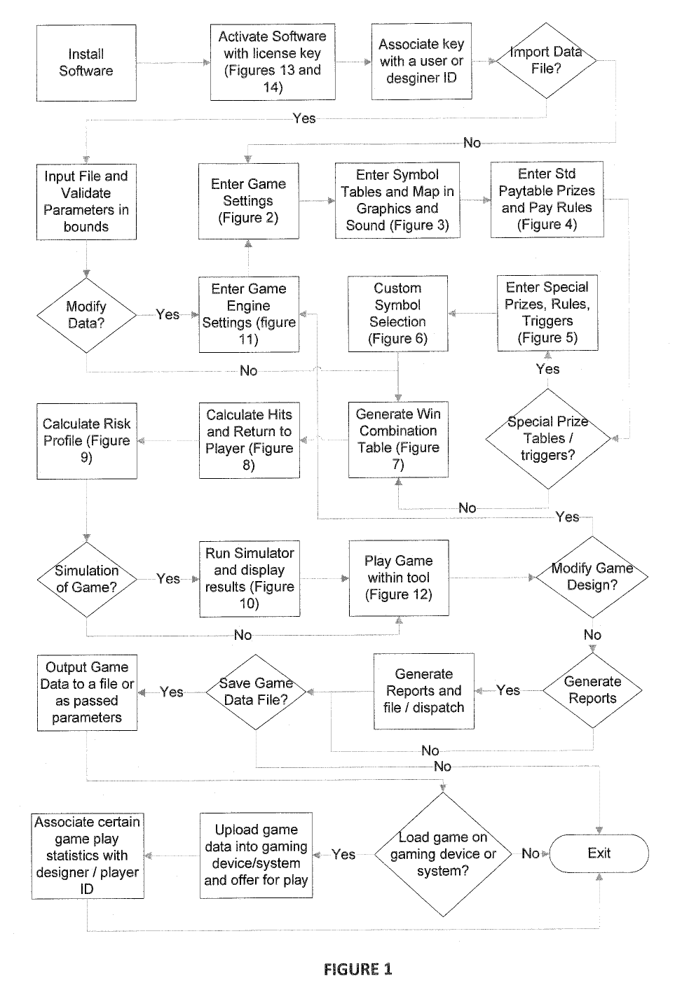

A professional game designer might follow, for example, the flow chart depicted in FIG. 1.

### Game Settings

When the game settings table is selected, the following FIG. (2) will be displayed. The first field is Game Name, its default is “slot machine game.” The second field is Number of Reel in slot machine game. The reel number can range from 1 to a designed limit (generally 16). The most frequently used reel number is 5 or 3 (default value). The Scatter multiplier can also be entered. The default value is 3 for slot games.

There are two types of payment including the pay high and pay all.

Pay High—The software spins all the possible combinations and checks each winning combination from the highest prize to the lowest. If the spinning combination belongs to the win combination at the first time, the frequency of occurrence counter in the winning combination will increase. Then the program stops checking winning combination and spins the next possible combination. In the most slot machine games, the highest win only will be chosen.
Pay Any—The software will then spin all the possible combinations and will check each winning combination from the highest prize to the lowest. If the spinning combination belongs to the win combination, the frequency of occurrence counter in the winning combination will increase. Then the program continues checking the remaining winning combinations. If this combination also belongs to other combinations, the frequency of occurrence counter in the winning combinations will increase respectively.

Since more than one win can be paid for a single winning pattern, i.e. coinciding wins added, not all coinciding wins are always paid. For example; if five symbols of a kind occur, then four and three of the same kind is not paid. To exclude this multiple paying, some combinations when awarded may exclude some other combination from being paid as well (e.g. five of a kind excludes four and three of a kind). This exclusion is handled by entering special win combinations.

Max number of special combinations is settings for feature game. Some special win combinations cannot be entered in a standard pay table so a special pay table can be used to input these combinations. For simplification, the user can enter a maximum number of special win combinations.
Max Sampling Size, Sampling Step and Simulation Trials are settings for game simulation of return to players. These parameters will control the simulation procedure and the required computation time. Sampling size for simulation will vary from sampling step to maximum sampling size. For each different sampling size, simulation will be done in a number of simulation trials. Then software can compute some statistics for return, such as maximum, minimum, average return and standard deviation. Simulated return and standard deviation should match theoretical return and volatility.
Symbol Table Entries—When the symbol table tab is selected, the following spreadsheet in FIG. (3) will be displayed. The symbol distribution information can be entered. The first column requests the symbol name. The following columns are for the corresponding number of those symbols occurring on each of the reels. The total reel number is entered in the previous settings. The second last column is symbol type i.e. scatter, substitute or normal symbols. The user can select from a drop list. The default one will be the normal symbol if the user does not select. The last column is used to link to the graphic file to be used for display by the game engine. It should be noted that graphic should jpg or bmp file. And size must preferably be 128×128. A further column for sound could be added. Note: The user can simply choose the Edit-Paste function in the menu to copy all symbol distributions into symbol table. The user can also select all items in the symbol table and Edit-Copy them to Word or Excel etc. software. These functions can significantly reduce data entry time.
Standard Pay-Table Entries—When the Standard Pay Table tab is selected, FIG. (4) will be displayed. The first column refers to the symbol name. The following columns are pay prices and pay method for winning combinations consisting of the same symbol with different combinations on each reel. The total reel number is entered in the previous options. The last column is pattern type including scatter, substitute and none. The tool caters for play rules such as: Win directions (left, right, both, any), Scatter, and scatter multiplier, Symbols that substitute for this symbol. The user can also simply choose the Edit-Paste function from the menu to copy a pay combination into the table. The user can select all items or part in the standard table and Edit-Copy them to Word or Excel etc. software. These functions can significantly reduce data entry time.
Special Pay Table or Feature Game Entries-Some symbol combinations cannot be entered in the standard pay table. However these can be done through a special pay table for feature games. They are additional to the standard pay table. When the special pay table tab is selected, FIG. (5) will appear.

All the win combinations can be entered in this tab including standard pay table. However, it is more time consuming compared to the standard pay table. The first 1-N (number of reels) column refers to the symbol combination on each reel. The total reel number is entered in the previous options. The third last column is the pay method including pay left, pay right, pay both and pay any. The second last column is prize pay. The last one is pay pattern including scatter, substitute and none. When the (−) WINDOWS command button is clicked, one will see the FIG. (6) symbol selection. In this dialog, you can enter any combination of all symbols on each reel. A symbol combination can be identified in the game output file to set a flag to trigger a second screen or feature game or jackpot or some other game outcome dependent on a prior outcome.

Win Combination Table—After executing the theoretical calculation, the FIG. (7) win combination table will be displayed. This table lists all winning combinations including standard pay table and special pay table. The contents include symbol names on each real, pay price, methods, hits and return rate.
Calculation Algorithm—The program will ask the user to enter the summary of the reel-strips, symbol distribution and the winning combinations. The program will then spin all the possible combinations and will increment each winning combination “frequency of occurrence” counter. The method in which the program scans through the winning combinations in order to decide the prizes can be set manually. This allows great flexibility along with the performance of extremely complex calculations. One bit in software is designed to represent one symbol. It is the fastest way to determine that the combination belongs to a winning combination or not. The maximum number of symbols is 32, however, it can be easily expanded to 64 or 128 and so on, as can the number of reel be expanded to a virtually unlimited number. The limit on the number of special winning combinations is dependant upon computer memory and the amount of free space available in the hard disk. The time that the program performs the calculations is dependant upon a few factors, namely, the number of reels, symbols and winning combinations. Most typical calculations can be finished in less than 2 seconds. The time taken to perform game simulations (if selected) is dependent on the sample size and the number of samples required.
Prize Table—After executing the theoretical calculation, the FIG. (8) prize table will be displayed. This table lists pay prize, hits and return for all different prizes including standard pay table and special pay table. The last row will give overall return to player.
Volatility Table—After executing theoretical calculation, the FIG. (9) volatility table will be displayed. This table lists the theoretical standard deviation on different simulation trials of game play. It also includes minimum and maximum return rate to player.
Simulation Results—The Max Sampling Size, Sampling Step and Simulation Trials are settings for game simulation of return to players. These parameters are entered in the game settings. For each different sampling size, simulation will be done in number of simulation trials. Then software can compute some statistics for return, such as maximum, minimum, average return and standard deviation. Simulated return and standard deviation should match theoretical return and volatility. FIG. (10) gives an example for simulation results.
Game Engine—In the menu Game Engine, you can use the current game settings to play the game the user just designed. In the Alternate the game engine could be embedded in a gaming device or system and the design tool would upload the game files directly to enable real-time ‘design and play’.
Game Engine Settings—The user can select the preferred picture for game background and initial intake for play as FIG. (11) for the simulation. In the live gaming environment the ‘initial stake’ would be replaced by the actual credit meter value. The game background size must preferably be 1024×1024 or larger.
Game Engine—The user can select Game engine ->play from the menu and play the game they just designed as FIG. (12)
User can change amount of bets for each spin. The default is 1 cent. The Game will not continue when there is not enough money (credit).
Tool Installation and Licensing—When the user installs the Game Math Tool, the licensing key can be entered in FIG. (13). The licensing key will be stored in a registry database. There are two different licensing keys. One is used to compute the theoretical return rate for the slot machine game. Another key can be used for both Game Engine play and math calculation. This enables the same software to be sold as either a testing tool or a design tool. The GameMath tool will not work properly if the user does not correctly install the licensing key. The user needs to send license data back to the ultimate owner of the game tool software (and hence the key generator) to obtain a license key. If ‘activate license’ under menu license is chosen, the license data is displayed in FIG. (14). The user can enter license data.
Data Files—The user can import data files directly into the game design tool, to save having to repeat data entry. The user can also export a data file to a file and save their work. This exported file is essentially the ‘game definition file’ that can be then uploaded into a gaming device or system or used by the tool itself to offer the games for play.
The data file may also be interpreted and presented in a report format (non-usable for play), for a regulatory agency or customer or other third party use.
Input Validation—The program checks that inputs (manually entered) are valid. Inputs using intuitive interfaces (such as a slide or a dial) will always be within acceptable pre-programmed tolerances.
Designer Tag—Using the encryption key generator, a key or tag that is unique to the designer can be embedded in, or used to secure the game output file to enable business methods where association of a designer with a game is needed. For example, in the payment of royalties, virtual ‘junket operations’, and so on.

### Alternate Embodiment

### Intuitive Design Tool Game Designed Using an Intuitive Interface

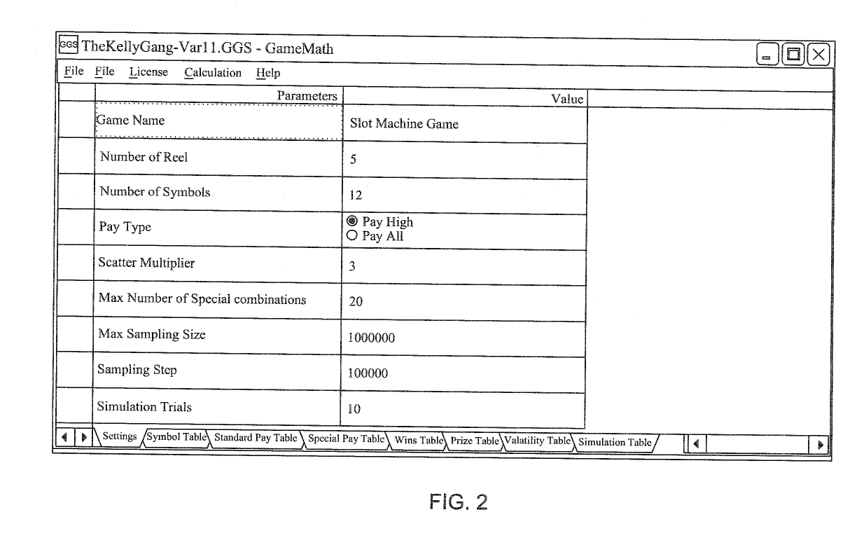

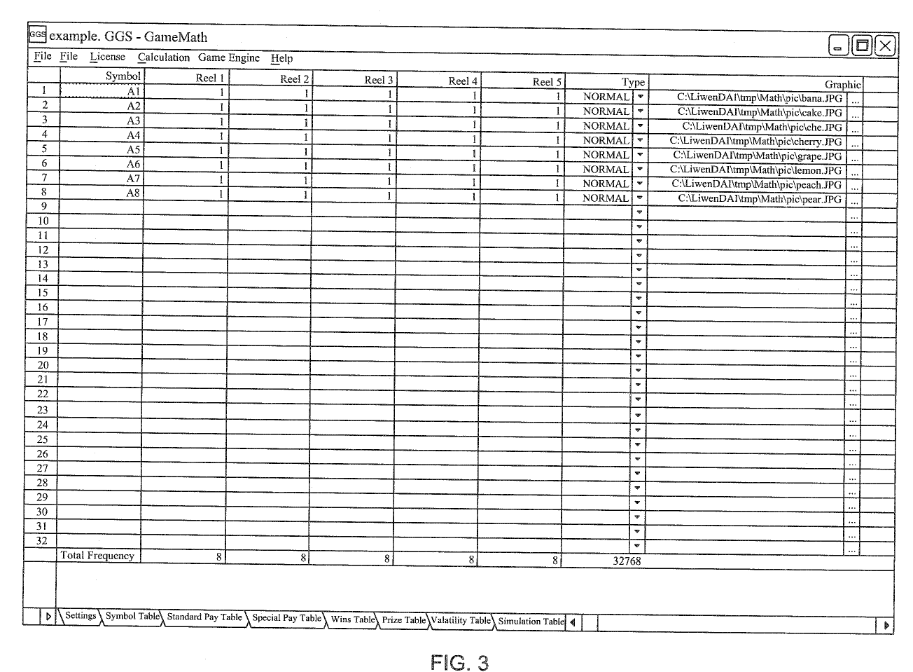

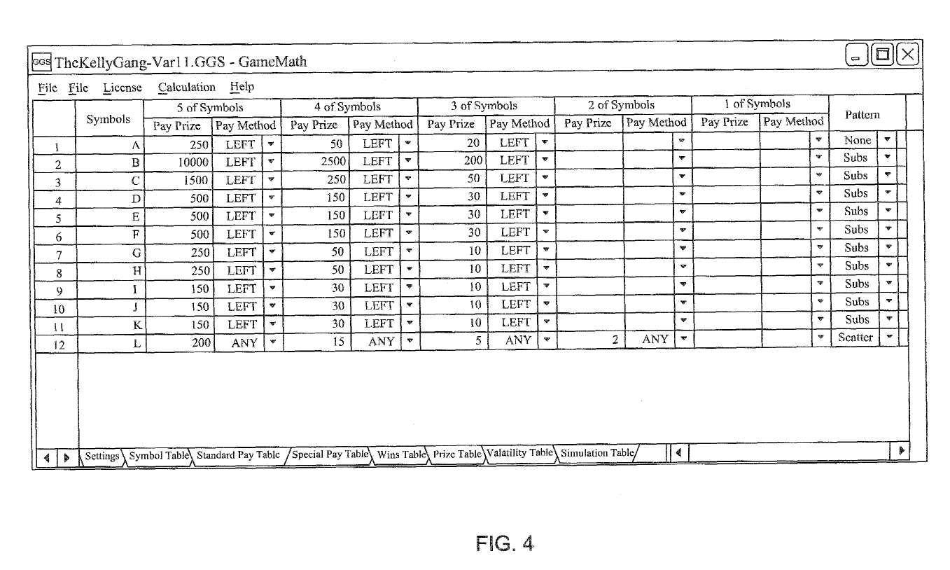

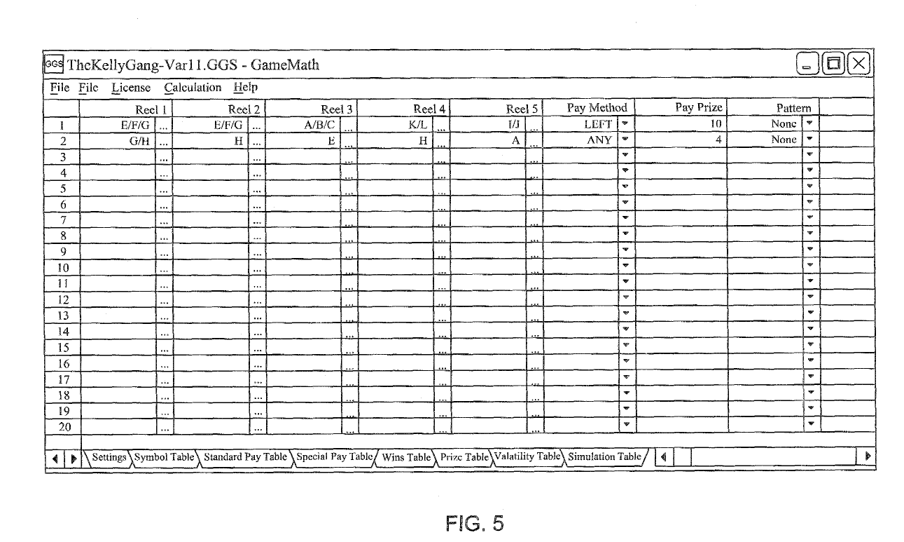

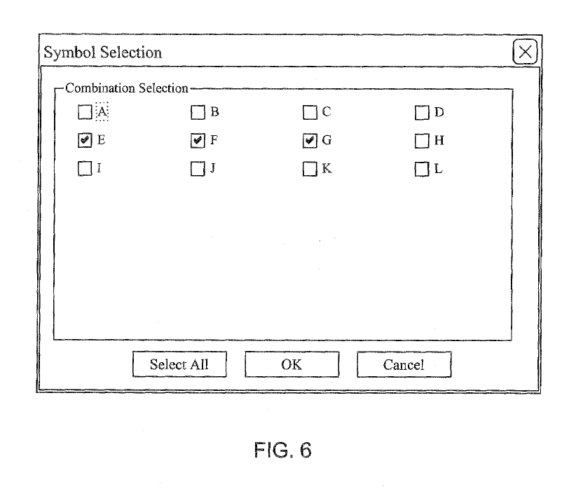

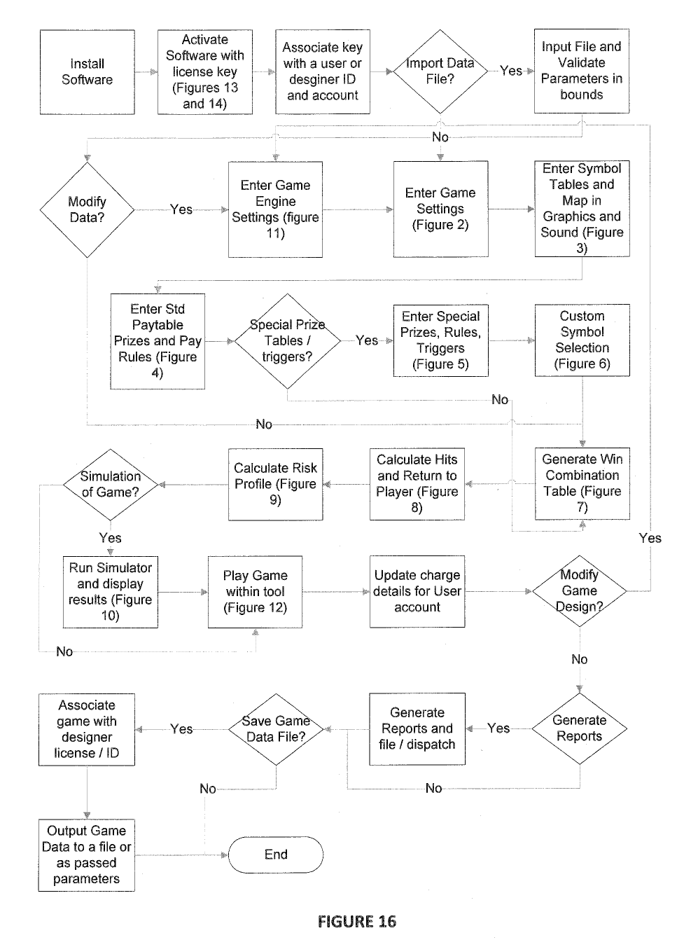

In another embodiment the initial game would be designed, output or input parameters permitted to be modified would be set and the limitations on variance in the output parameters set. For example, return to player or hit rate or volatility not to exceed a certain threshold. This embodiment is exemplified by the flow chart in FIG. 15. Within that set threshold certain parameters such as those set in FIG. 2 through FIG. 6 could be adjusted directly, for example, more symbol on one reel and less on another (or in the alternative, adjusted indirectly through the reverse engineering of the industry standard calculations used to derive adjusted output parameters as demonstrated in FIGS. 7 through 10).

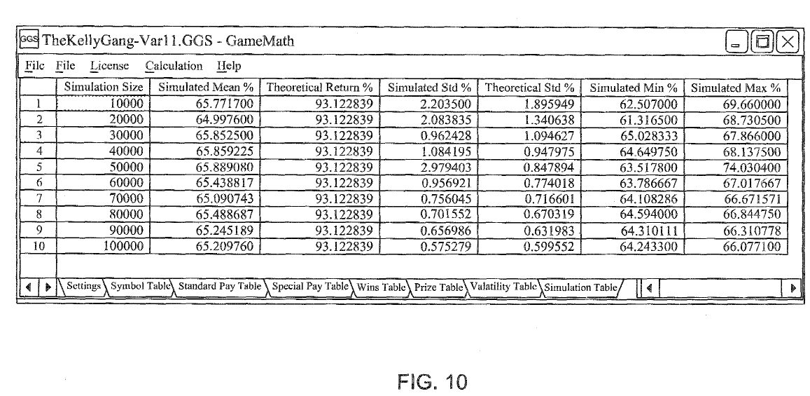

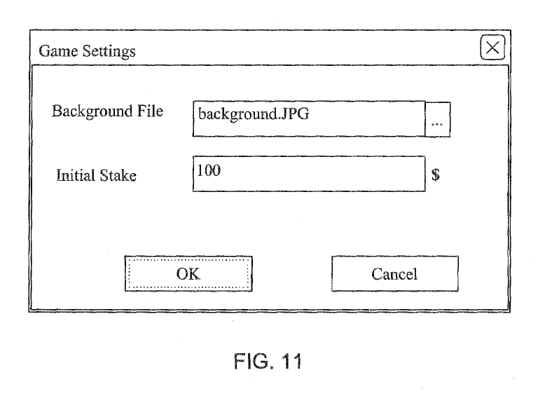

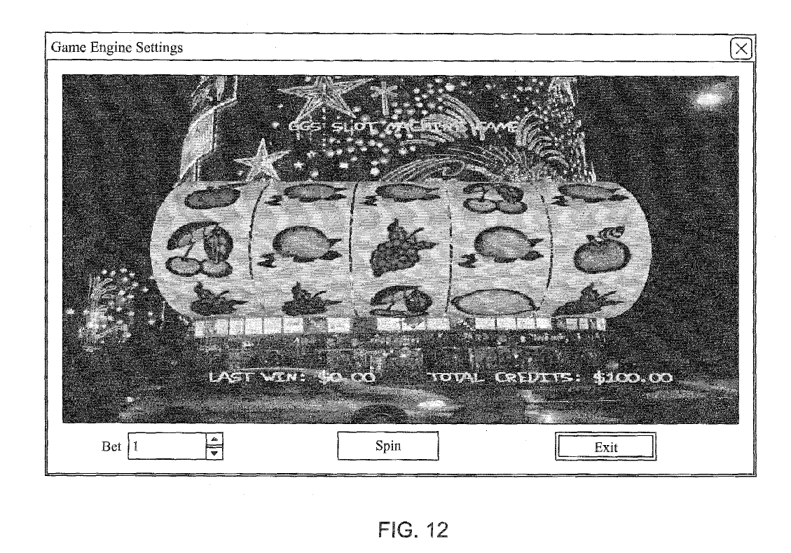

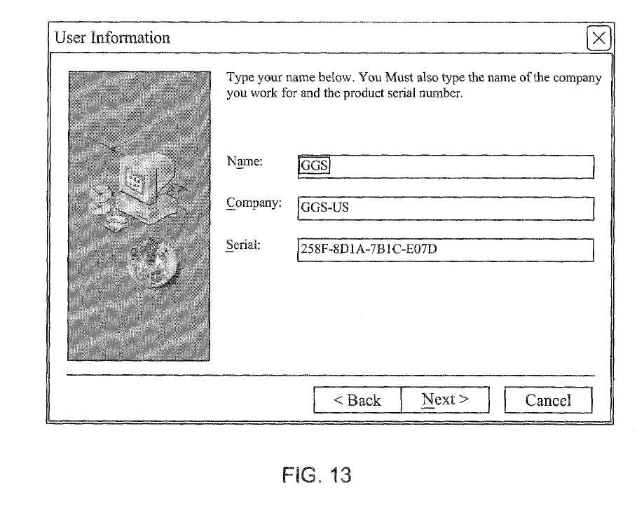

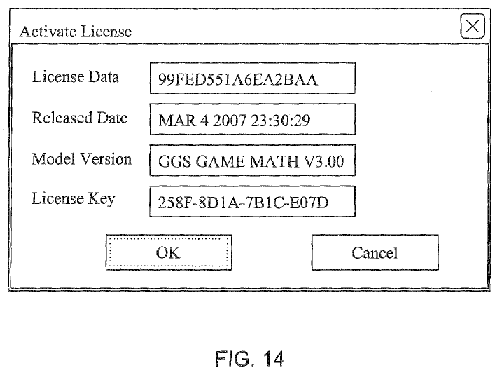

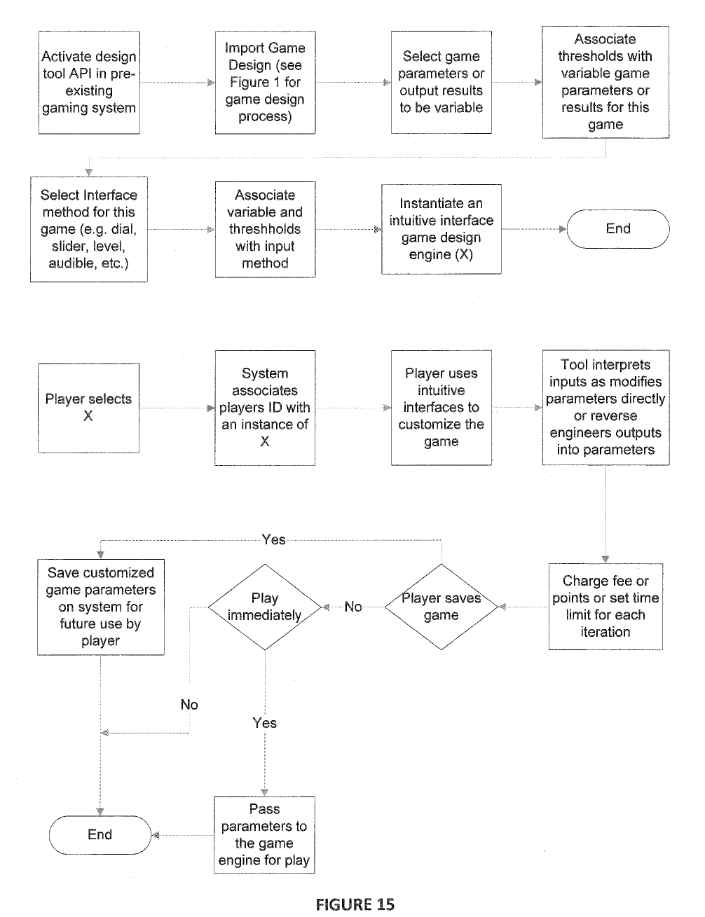

The adjustment would be via the game design tool interpreting the position of a user interface such as a dial or a slide bar or a voice command or a lever action and modifying certain game parameters to respond to the user's wishes, but not exceed the thresholds. The intuitive user commands would translate a ‘yes’ or ‘no’, or a ‘more’ or ‘less’ for example, into modified input or output parameters that ultimately result in a modified game design. Some examples of customer selection follows:
1. Jackpot—Yes/No (could turn off the trigger and automatically adjust the return to player through reel distribution or other means to still be within regulatory or other limitations).
2. Feature games—Yes/No (could turn off the trigger and automatically adjust the return to player through reel distribution or other means to still be within regulatory or other limitations).
3. Pay often (could adjust the hit rate).
4. Pay not so often (could adjust the hit rate).
5. Pay more (could adjust the hit rate).
6. Pay less (could adjust the hit rate).
7. More smaller prizes and less larger ones.
8. Less small prizes and greater value of the large ones.
9. The frequency of pay might be represented in another form such as by a meter or a bar or sliding scale.
10. Select the symbols to be on the reels (for example, replace a cherry with the symbol of the favourite ball team). As per the last column of FIG. 2, only this would be more intuitive such as a ‘drag and drop’ as opposed to typing in a directory location. In one embodiment pictures on the user's cell phone could be e-mailed through to the gaming device.
11. Select the background graphics. As per FIG. 10 only this would be more intuitive such as a ‘drag and drop’ as opposed to typing in a directory location. In one embodiment pictures on the user's cell phone could be e-mailed through to the gaming device so they could have a picture of their dog, for example as the background graphics to the game.
12. Select a theme.
13. Select a language.
14. Select a currency.
15. Select where on the screen the meter should be.

### Alternate Embodiment

### Pay Per View

### “Pay Per View”

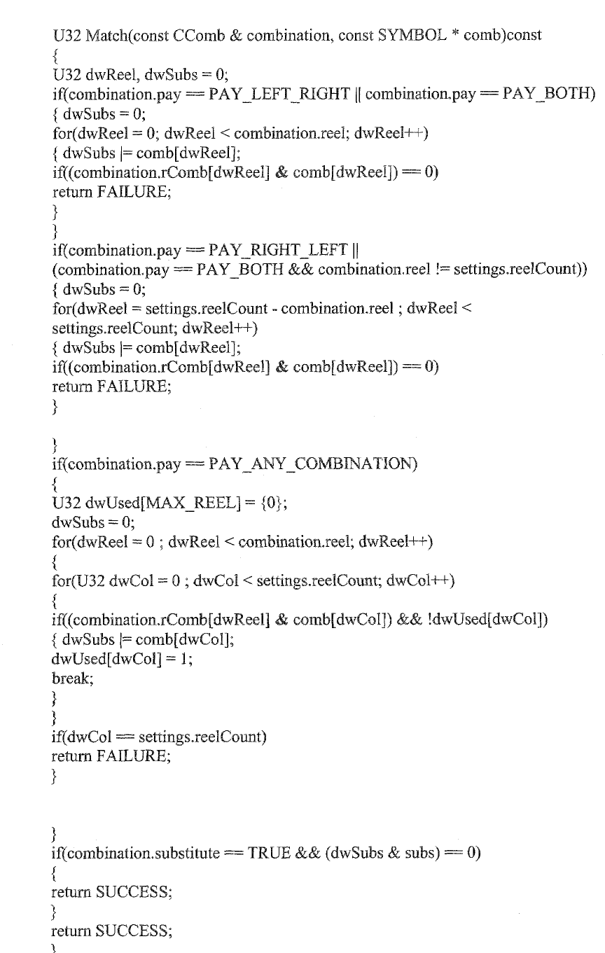

In another embodiment (as exemplified in FIG. 16) the process of game design is essentially commoditized whereby anyone can establish an account, download the tool, acquire a unique license/user ID and essentially follow a similar workflow as in FIG. 1. In one embodiment for each iteration of game design the user is charged a fee. The user “owns” the final game design, which is tagged with the unique user ID.

While the present invention has been disclosed with reference to particular details of construction, these should be understood as having been provided by way of example and not as limitations to the scope or spirit of the invention.

What is claimed is:

1. A computer-readable medium having stored thereon instructions that, when executed by a computer, causes the computer to display an interactive graphical interface that enables a user to design and modify statistical parameters of an electronic game of chance by providing input parameters to the computer;
the computer using the input variables to specify the output parameters and provide an output that is used to cause the electronic game of chance to perform in accordance with the input parameters.

2. The computer-readable medium of claim 1, wherein:
the instructions further comprise instructions for generating, as said output, a data file representative of the parameters that is readable by a game engine so that the game engine can run a game that is representative of the input parameters.

3. The computer-readable medium of claim 1, wherein:
the instructions further comprise a game engine that can use as inputs, the output, to display an electronic game of chance that performs in accordance with the input parameters.

4. The computer-readable medium of claim 1, wherein:
the output comprises data selected from the group comprising: rate, return to player, pay-table, risk profile, or simulation results.

5. The computer-readable medium of claim 1, wherein:
the output is a game file that is saved on a server for recall or use at a later time.

6. A business method comprising:
publishing, from a server, a tool that may be accessed via the internet;
the tool enabling a person to pay a fee, design and trial-play a game, and obtain the data that defines the designed game.

7. The method of claims 6 where;
the tool may be used in isolation of a gaming system to design and deploy games.

8. The method of claims 6 where;
the tool may be used in conjunction with a gaming system to design and deploy games.

9. The method of claims 6 where;
the tool comprises instructions that, when executed by the server, causes the server to provide an interactive graphical interface that enables a user to design and modify statistical parameters of an electronic game of chance by providing input parameters to the server;
the server using the input parameters to specify the output parameters and provide an output that is used to cause the electronic game of chance to perform in accordance with the input parameters.
